(19) United States
(12) Patent Application Publication
(10) Pub. No.: US 2007/0116797 A1
(43) Pub. Date: May 24, 2007

(54) Ejector pin and injection mold with the ejector pin

(76) Inventors: Ching-Chang Wang, Tu-Cheng City (TW); Chih-Yu Chen, Tu-Cheng City (TW); Jian-Guang Huang, Tu-Cheng City (TW); Fang Liu, Tu-Cheng City (TW)

Correspondence Address: LIN & ASSOCIATES INTELLECTUAL PROPERTY, P.O. BOX 2339, SARATOGA, CA, 95070-0339, US

(21) Appl. No.: 11/287,333

(22) Filed: Nov. 23, 2005

(51) Int. Cl. B29C 45/22

(52) U.S. Cl. 425/556

(57) ABSTRACT

An ejector pin includes a pin shaft and a pinhead locating on one end of the pin shaft. The pin shaft and the pinhead are eccentric and have different axle centers. The caliber of the pinhead is bigger than that of the pin shaft. An injection mold with the ejector pin includes a pushing board which forms at least one head-receiving cavity and one shaft hole extending from the head-receiving cavity to receive the ejector pin. The head-receiving cavity and the shaft hole are eccentrically arranged. When the injection mold is opened, the ejector pin stretches into a mold housing formed between a female core and a male core of the injection mold and pushed a product out of the mold housing. The ejector pin is fixed in the pushing board to avoid rotating of the ejector pin when pushing the product out of the mold housing.

### BACKGROUND OF THE INVENTION

1. Field of the Invention

The present invention relates to an ejector pin and an injection mold with the ejector pin, and more particularly to an ejector pin with eccentric mechanism for avoiding the rotation of the ejector pin.

2. The Related Art

An ejector pin is used to push the product out of the mold. As shown in FIG. 8 and FIG. 9, a first conventional ejector pin 10a includes a pin shaft 12a and a pinhead 14a located on one end of the pin shaft 12a. The other end of the pin shaft 12a is flat. The pin shaft 12a and the pinhead 14a are cylinder and have the same axle center ◯₁. Because the ejector pin 10a easily rotates around the axle center ◯₁, the ejector pin 10a is usually used in the condition that the surface of the product is flat. While the surface of the product is curved, the flat end of the pin shaft 12a injures the product and must be made into curved shape coupled to the surface of the product. Meantime, the ejector pin 10a must be fixed in the mold to avoid the surface of the product hurt by the rotation of the ejector pin 10a.

As shown in FIG. 10 and FIG. 11, a second conventional self-fixed ejector pin 10b is improved from the ejector pin 10a. The flat end of the pin shaft 12b is made into ramp to match to the surface of the product. A D-shape head 14b is grinded from the cylinder pinhead 14a. The pin shaft 12b and the D-shape head 14b have the same axle center ◯₂.

Referring to FIG. 12 and FIG. 13, in order to fix the self-fixed ejector pin 10b in the mold, a special cavity 16b of football field shape must be milled in the mold to receive the D-shape head 14b. Through the mating of the D-shape head 14b and the special cavity 16b, the rotation of the self-fixed ejector pin 10b is avoided. But the special cavity 16b is difficult to be formed by milling. After a round hole is milled it requires moving the mill cutter back and forth for several times to form the special cavity 16b. This complex procedure wastes a lot of time and increases the cost.

### SUMMARY OF THE INVENTION

Accordingly, an object of the present invention is to provide an ejector pin comprising a pin shaft and a pinhead located on one end of the pin shaft. The pin shaft and the pinhead are cylinder and have different axle centers. The caliber of the pinhead is bigger than that of the pin shaft. Because the pinhead is cylinder, the process of the production is simplified and the cost is reduced.

Another object of the present invention is to provide an injection mold with the ejector pin. The injection mold comprises a first fixed board, a female mold bellow the first fixed board, a female core located in the female mold, a male mold bellow the female mold, a male core located in the male mold, a mold housing formed between the female core and the male core, a second fixed board bellow the male mold, a pair of side boards fixed between the second fixed board and the male mold, a cavity formed between the side boards, a first pushing board located in the cavity defined by the side boards, and a second pushing board fixed bellow the first pushing board. The first pushing board defines a head-received cavity at the bottom and a shaft hole stretching from the top potion of the first pushing board to the bottom communicating with the head-received cavity. The pin shaft hole and the head-received cavity are eccentric and coupled with the pin shaft and the pinhead. The eccentric ejector pin and the eccentric pin shaft hole and head-received cavity are easy to be manufactured. When the ejector pin pushes the product out of the mold housing, any rotation of the ejector pin is avoided.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of an injection mold with an ejector pin in accordance with the present invention;

FIG. 2 is a perspective view of the ejector pin in accordance with a first embodiment of the present invention;

FIG. 3 is a side view of the ejection pin while fixed in the injection mold in accordance with the first embodiment of the present invention;

FIG. 4 is a top view of the ejector pin which is fixed in the injection mold, showing that the pin shaft and the pinhead are eccentric;

FIG. 5 is the side view of the ejector pin while fixed in the injection mold in accordance with a second embodiment of the present invention;

FIG. 6 is the top view of the second embodiment of the ejector pin which is fixed in the injection mold, showing that the pin shaft and the pinhead are eccentric;

FIG. 7 is an enlarged view of the potion VII in FIG. 1;

FIG. 8 is a front view of a first conventional ejector pin;

FIG. 9 is the top plane view of the conventional ejector pin shown in FIG. 8;

FIG. 10 is the front view of a second conventional self-fixed ejector pin;

FIG. 11 is the top plane view of the second conventional self-fixed ejector pin shown in FIG. 10;

FIG. 12 is the side view of the second conventional self-fixed pin which is fixed in the injection mold;

FIG. 13 is the top view of the second conventional self-fixed ejector pin fixed in the injection mold.

### DETAILED DESCRIPTION OF THE PREFERRED EMBODIMENTS

For facilitating understanding, like components are designated by like reference numerals throughout the various embodiments of the invention as shown in the attached drawings.

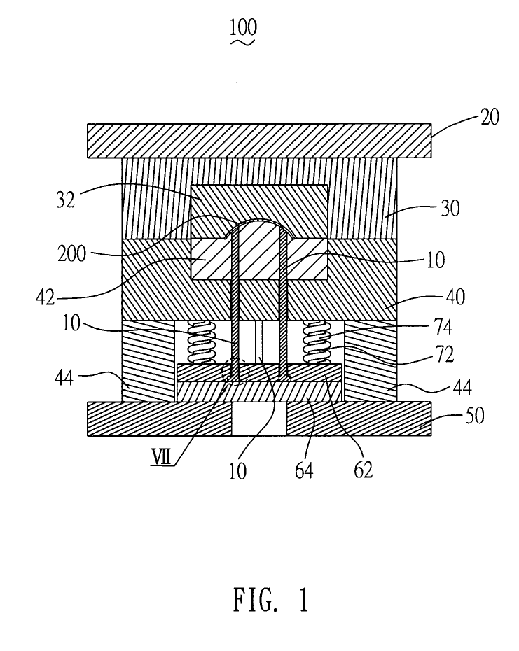

Now referring to FIG. 1, which shows a cross-section view of a injection mold 100 with an ejector pin 10 in accordance with the present invention. The injection mold 100 includes a first fixed board 20, a female mold 30 fixed bellow the first fixed board 20, a female core 32 located in the female mold 30, a male mold 40 located bellow the female mold 30, a male core 42 located in the male mold 40, a second fixed board 50 fixed bellow the male mold 40 and a plurality of side boards 44 fixed between the male mold 40 and the second fixed board 50. The side boards 44, the male mold 40 and the second fixed board 50 define a cavity which receives a first pushing board 62 and a second pushing board 64. The second pushing board 64 is fixed bellow the first pushing board 62. A plurality of locating pins 72 are fixed on the first pushing board 62. Each locating pin 72 has a spring 74 and stretches into a hole (not shown) formed in the male mold 40.

While the female mold 30 is closed with the male mold 40, a mold housing (not shown) is formed between the female core 32 and the male core 42 to hold a product 200. The ejector pin 10 is fixed in the first pushing board 62 and stretches through the male mold 40 to the mold housing. While the injection mold 100 is open, the first pushing board 62 and the second pushing board 64 slide up and down in the cavity. Accordingly, the ejector pin 10 is driven up and down. Then the product 200 is pushed out of the mold housing.

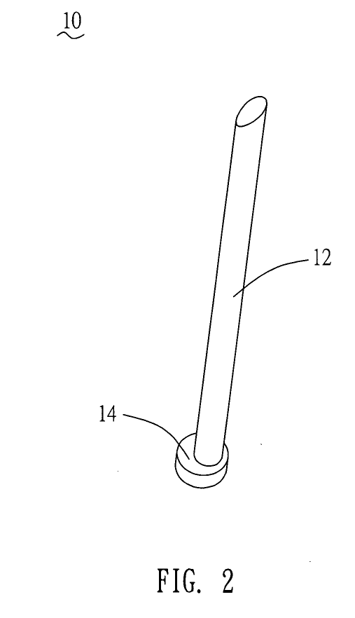

FIG. 2 shows a first embodiment of the ejector pin 10 of the present invention. The ejector pin 10 includes a pin shaft 12 and a pinhead 14 located at bottom end of the pin shaft 12. The pin shaft 12 and the pinhead 14 are cylinder and have different axle centers. The caliber of the pinhead 14 is bigger than that of the pin shaft 12. The top portion of the pin shaft 12 is a ramp surface to contact with the surface of the product 200.

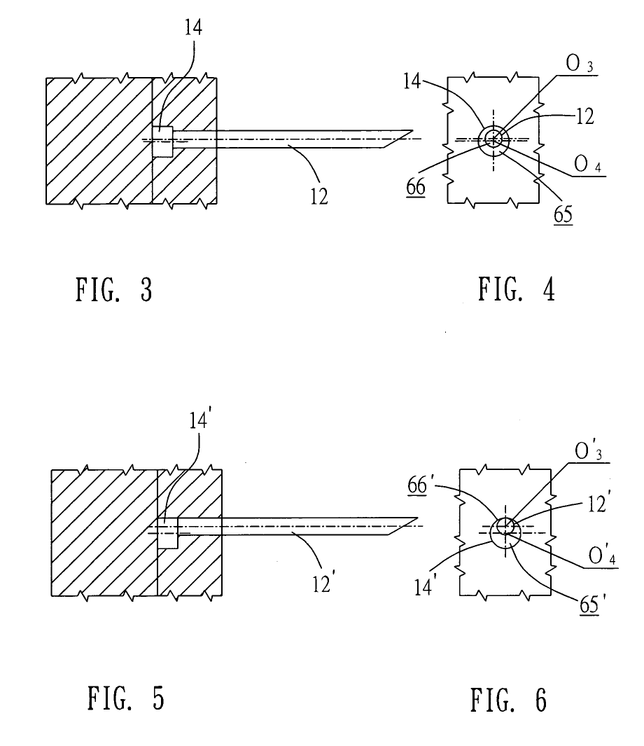

FIGS. 3-4 show the ejector pin 10 fixed in the first pushing board 62. The pinhead 14 and the pin shaft 12 are eccentrically arranged and have different axle centers. That is, the projection of the pin shaft 12 forms a circle ◯₃ on the pinhead 14. The circle ◯₃ is seated in the circle ◯₄ formed by the pinhead 14. The circles ◯₃ and ◯₄ are eccentric circles and the circles ◯₃ is enclosed in the circles ◯₄. The circles ◯₃ and ◯₄ have no portion to contact with each other.

As shown in FIGS. 5-6, there is a second embodiment of an ejector pin 10 of the present invention. The ejector pin 10 includes a pin shaft 12′ and a pinhead 14′ located at bottom end of the pin shaft 12′. The pinhead 14′ and the pin shaft 12′ are eccentrically arranged and have different axle centers. The projection of the pin shaft 12′ forms a circle ◯′₃ and the projection of the pinhead 14′ forms a circle ◯′₄. The circle ◯′₃ is located in the circle ◯′₄. The circle ◯′₃ and ◯′₄ are eccentric circles and tangent with each other. That is, the projections of the pin shaft 12′ and the pinhead 14′ form a pair of tangent circles ◯′₃ and ◯′₄.

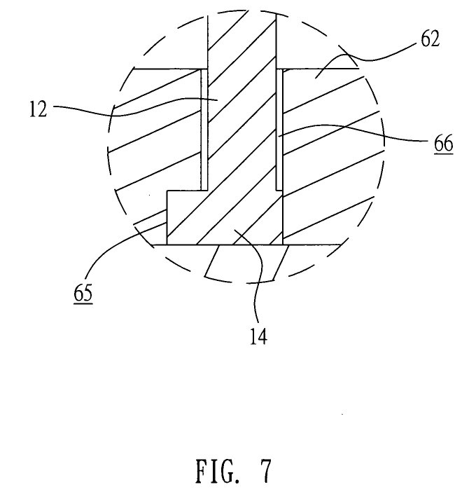

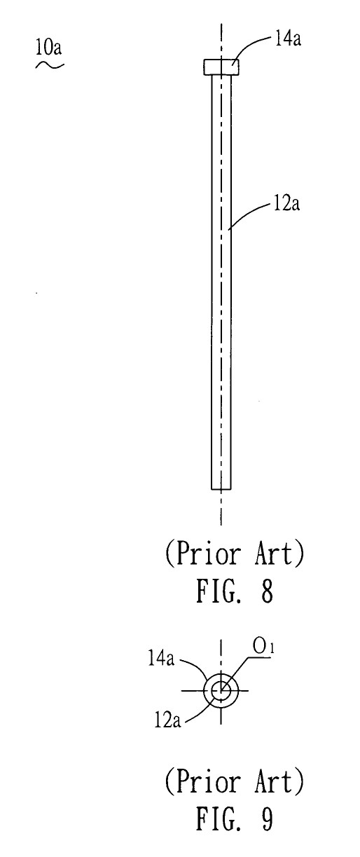

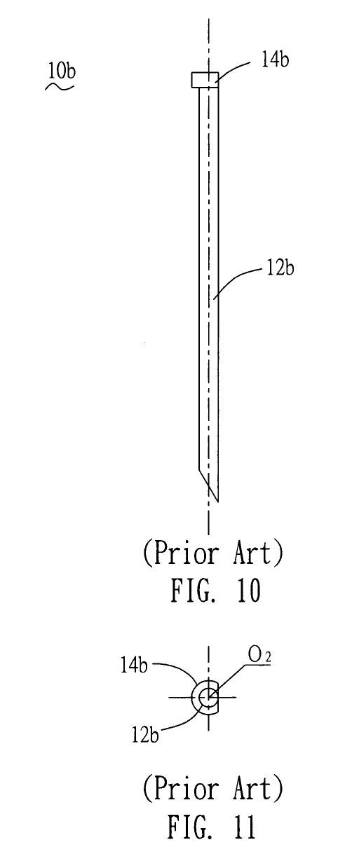

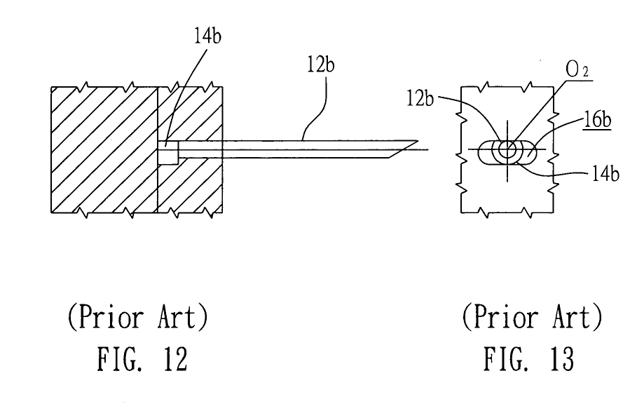

As shown in FIG. 7, the first pushing board 62 defines at least one head-receiving cavity 65 at the bottom and a shaft hole 66 which is extends from the head-receiving cavity 65. The head-receiving cavity 65 is a cylinder in according to the shape and size of the pinhead 14. The shaft hole 66 is a cylinder in according to the shape and size of the pin shaft 12. That is, the head-receiving cavity 65 and the shaft hole 66 are eccentrically arranged. The shaft hole 66 extends through the first pushing board 62 and communicates with the head-receiving cavity 65. The shaft hole 66 and the head-receiving cavity 65 have different axle centers in according to the axle centers of the pin shaft 12 and the pinhead 14. Therefore, the ejector pin 10 is inserted in the cavity 65 and the shaft hole 66 for fixing the ejector pin 10 in the injection mold 100.

While assembling, the pin shaft 12 is inserted into the shaft hole 66 from the bottom of the first pushing board 62. When the injection mold 100 is close, the pin shaft 12 extends through the male mold 40 and the male core 42 to the mold housing. The pinhead 14 locates in the head-receiving cavity 65. Because of the different axle centers of the shaft hole 66 and the head-receiving cavity 65 the ejector pin 10 is fixed there without rotation. Then, the second pushing board 64 is fixed bellow the first pushing board 62. When the mold is open, the first and second pushing boards 62 and 64 slide up and down and drive the ejector pin 10 to push the product 200 out of the mold housing.

In this invention, both the pin shaft 12 and the pinhead 14 are designed as a cylinder. It can be easily manufactured by only one step. Comparing with the complex process of the conventional self-fixed ejector pin 10b, the pin shaft 12 of the present invention is simple and easy to achieve. It doesn't need to grind the cylinder pinhead 14 into D shape. Accordingly, in order to form the head-receiving cavity 65, it only needs to mill a cylinder cavity according to the shape of the pinhead 14. It avoid the complex process of moving the mill cutter in the cavity back and forth for several times to form a football field shape.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An ejector pin, comprising:
a pin shaft of cylinder shape;
a pinhead of cylinder shape locating at bottom end of said pin shaft;
the caliber of said pinhead being bigger than the caliber of said pin shaft; and
said pinhead and said pin shaft being eccentrically arranged and having different axle centers.

2. The ejector pin as claimed in claim 1, wherein the projection of said pin shaft forms a circle which is enclosed by a circle formed by the projection of said pinhead but not tangent.

3. The ejector pin as claimed in claim 1, wherein the projections of said pin shaft and said pinhead form a pair of tangent circles.

4. The ejector pin as claimed in claim 1, wherein the top potion of said pin shaft is a ramp surface.

5. An injection mold with the ejector pin as claimed in claim 1, comprising:
a first fixed board;
a female mold located bellow said first fixed board;
a female core received in said female mold;
a male mold located bellow said female mold;
a male core received in said male mold;
a mold housing formed between said female core and said male core to hold a product;
a second fixed board located bellow said male mold;
a plurality of side boards fixed between said male mold and said second fixed board to form a cavity;
a first pushing board located and sliding up and down in said cavity, said first pushing board defining at least one head-receiving cavity and at least one shaft hole extending from said head-receiving cavity to receive said ejector pin; and;
a second pushing board fixed bellow said first pushing board to fix said ejector pin.
